(19) United States
(12) Patent Application Publication
(10) Pub. No.: US 2014/0278506 A1
(43) Pub. Date: Sep. 18, 2014

(54) AUTOMATICALLY EVALUATING AND PROVIDING FEEDBACK ON VERBAL COMMUNICATIONS FROM A HEALTHCARE PROVIDER

(71) Applicant: Contagious Change LLC, Mesa, AZ (US)

(72) Inventors: Diane M. Rogers, Mesa, AZ (US); Jon P. Rogers, Mesa, AZ (US)

(73) Assignee: Contagious Change LLC, Mesa, AZ (US)

(21) Appl. No.: 14/214,470

(22) Filed: Mar. 14, 2014

Related U.S. Application Data
(60) Provisional application No. 61/799,305, filed on Mar. 15, 2013.

(51) Int. Cl. G06F 19/00

(52) U.S. Cl. CPC G06F 19/3487
USPC 705/2

(57) ABSTRACT

Systems and methods for automatically evaluating and providing feedback on verbal communications of a healthcare provider in real-time or near real-time may involve a mobile device. A plurality of configured communication quality parameters may be stored in memory of the mobile device. Audio data produced by the healthcare provider during interaction with a patient may be received through a microphone of the mobile device. The systems and methods may involve executable instructions stored in memory that, when executed, may extract communication quality data from the audio data based on the communication quality parameters, generate feedback information based on the extracted communication quality data, and display the feedback information in real-time or near real-time via a graphical user interface.

### CROSS-REFERENCE TO RELATED APPLICATION

This application claims the priority benefit of U.S. Provisional Application No. 61/799,305, filed Mar. 15, 2013 and titled “Automatically Evaluating and Providing Feedback on Verbal Communications from a Healthcare Provider,” the disclosure of which is incorporated herein by reference.

### BACKGROUND

The present disclosure relates to healthcare provider communication quality. More specifically, the present disclosure concerns mobile devices, systems, and methods for automatically evaluating and providing feedback on verbal communications from a healthcare provider.

A healthcare provider's ability to deliver effective and well-received healthcare services depends significantly on his or her ability to verbally communicate with patients. For purposes of this disclosure, the term “healthcare provider” may include any person that facilitates the delivery of healthcare services, such as receptionist, nurse, physician's assistance, physician, surgeon, hospital administrator, or other related persons. Healthcare providers must verbally communicate with patients in a number of scenarios, such as when prescribing a medication, when educating a patient on treatment options and associated risks to comply with informed consent requirements, when examining, evaluating, or assessing a patient, when administering treatments, or when building a quality, therapeutic relationship with a patient.

During such activities, the overall quality of a healthcare provider's interactions with a patient can be significantly influenced by not only whether the healthcare provider did or did not verbally communicate certain information, but also the manner in which it was communicated. For example, where a patient informs her physician that she is experiencing pain in her knee because she tripped and fell, the patient is more likely to view the quality of the healthcare provider's interaction with the patient as positive when the healthcare provider responds with a reflective statement that both acknowledges and validates the patient's feelings, concerns, and conditions (e.g., “Your fall could certainly be responsible for the pain in your knee. I can see that it is causing you quite a bit of pain”).

Alternatively, where a patient is considering a risky procedure, the patient is more likely to feel sufficiently informed prior to giving consent when a physician verbally reminds the patient that one treatment option is to forgo treatment altogether and wait to see if the condition changes (e.g., “Although I recommend undergoing the procedure, it's important to remember that another option includes not treating the condition at all and waiting to see if it improves.”)

Healthcare providers currently receive feedback on the quality of their verbal communications through the use of patient surveys, which more often than not are distributed in paper form. Such surveys typically contain a “Communication Composite” consisting of three broad questions, such as: (1) “How often did the healthcare provider explain things in a way you could understand?” (2) “How often did the healthcare provider listen carefully to you?” or (3) “How often did the healthcare provider treat you with courtesy and respect?” The forms provide fields for a patient to respond with a frequency-based answer, such as “Never,” “Sometimes,” “Usually,” or “Always.” The benefits of using such surveys are severely limited. Only a fraction of all patients ever receive a survey, which is one of the main arguments that such survey methods fail to accurately reflect the feedback of the patient population with which any given healthcare provider may interact. Making matters worse, of the fraction of patients that do receive a survey, only a fraction of those recipients actually fill out and return the survey. For example, a typical emergency room doctor may see upwards of four hundred patients in a month. Only ten of those four hundred patients may receive a survey and only two of those ten may actually return a survey. Of the few patients that receive a survey, many either misplace it, find it too laborious and time-consuming to fill out, forget that they received it, or simply choose to ignore it.

The surveys that do get filled out can be inaccurate due to the nature of an average patient's visit to a healthcare provider. During an average visit, a patient may interact with and receive mental impressions about multiple healthcare providers. For example, a patient may need to interact with a first healthcare provider (e.g., a receptionist) while checking in, then with a second healthcare provider (e.g., a nurse) while having vitals taken, with a third healthcare provider while being diagnosed (e.g., a primary physician), with a fourth healthcare provider (e.g., a laboratory technician) while having a diagnostic test performed, and the list goes on. The survey is not written in a manner that allows patients to differentiate their mental impressions about the several individual healthcare providers with which they interacted. Rather, they are general and not specific to each individual healthcare provider. As a result, the surveys fail to generate data for each healthcare provider. Another issue is that, in some instances, patients may not be able to describe their feelings about the quality of a healthcare provider's verbal communications.

Companies in the remote customer service industry have previously attempted to monitor the quality of their representatives' verbal communications by using speech recognition and speech analytics software. However, such systems may only be used in fixed locations, such as a call center. As a result, they lack the portability that healthcare providers require as they walk in and out of various patient rooms throughout an average day. Moreover, such systems are ill-designed for automatically evaluating and providing feedback to users in real-time or near real-time. Using such systems, call center administrators record conversations between employees and customers and then, at a later time, analyze the recorded conversation to monitor employee performance.

Such systems fail to directly provide encouraging or constructive feedback to those actually doing the speaking in a timely manner. The delayed, inaccurate, or altogether missing feedback could otherwise allow for immediate diagnostic and corrective action by the speaker or positively acknowledge what is being done well to support continuing such actions and behaviors. More importantly, such systems are ill-equipped for use in the healthcare field, where verbally communicating medical information that is both precise and empathetic is paramount. A system suffering from similar limitations, which is directed at evaluating customer comments, is described in U.S. Pat. No. 8,635,237 issued to Bansal et al. Healthcare providers need a better system for receiving real-time or near real-time feedback on their verbal communications with patients so as to better deliver evidence-based healthcare.

Embodiments described herein provide for improved real-time or near-real time evaluation and feedback regarding verbal communications between healthcare providers and patients. A mobile device for automatically evaluating and providing feedback on verbal communications of a healthcare provider may include memory that stores a plurality of configured communication quality parameters. The mobile device may include a microphone that receives audio data produced by the healthcare provider during interaction with a patient. The mobile device may further include a processor that executes instructions stored in memory. Execution of the instructions by the processor may cause the mobile device to extract communication quality data from the audio data based on the communication quality parameters. Execution of the instructions may further cause the mobile device to generate feedback information regarding one or more communication skills of the healthcare provider based on the extracted communication quality data. The mobile device may also contain a graphical user interface that displays the generated feedback information in real-time.

A method of automatically evaluating and providing feedback on verbal communications of a healthcare provider may include storing in memory of a mobile device a plurality of configured communication quality parameters. The method may further include receiving through a microphone of the mobile device audio data produced by the healthcare provider during interaction with a patient. The method may also include executing instructions stored in memory of the mobile device. Execution of the instructions by a processor of the mobile device may cause the mobile device to extract communication quality data from the audio data based on the communication quality parameters. Execution of the instructions may further cause the mobile device to generate feedback information regarding one or more communication skills of the healthcare provider based on the extracted communication quality data. The method may further include displaying the feedback information in real-time or near real time through a graphical user interface.

A system for implementing the foregoing method may include a mobile device, a server, and a graphical user interface communicably coupled by a communication network. The mobile device may include a microphone that receives audio data produced by the healthcare provider during interaction with a patient. The mobile device may further a communication interface for wirelessly transmitting the audio data over the communication network. The server may include memory that stores a plurality of configured communication quality parameters and a communication interface for receiving the audio data sent wirelessly over the communication network from the mobile device. The server may further include a processor that executes instructions stored in memory. Execution of the instructions by the processor may cause the server to extract communication quality data from the audio data based on the communication quality parameters. Execution of the instructions by the processor may further cause the server to generate feedback information regarding one or more communication skills of the healthcare provider based on the extracted communication quality data. The graphical user interface may display the generated feedback information in real-time or near real time.

### BRIEF DESCRIPTION OF DRAWINGS

FIG. 1 is a block diagram of an exemplary network environment in which a system that automatically evaluates and provides feedback on verbal communications of a healthcare provider may be implemented.

FIG. 2 is a workflow diagram of an exemplary system that automatically evaluates and provides feedback on verbal communications of a healthcare provider.

FIG. 3 is a block diagram of an exemplary mobile device.

### DETAILED DESCRIPTION

Embodiments of mobile devices, systems, and methods for automatically evaluating and providing feedback on verbal communications of a healthcare provider are disclosed herein. Such embodiments provide for improved, real-time or near real-time evaluation and feedback regarding verbal communications between healthcare providers and patients. The embodiments allow a healthcare provider to freely travel around a healthcare facility visiting patients—as opposed to being tethered to an immobile computing device—without interrupting the evaluation and feedback process. For purposes of this disclosure, the term “healthcare provider” may include any person that facilitates the delivery of healthcare services, such as receptionist, nurse, physician's assistance, physician, surgeon, hospital administrator, or other related persons.

In an embodiment, a mobile device for automatically evaluating and providing feedback on verbal communications of a healthcare provider may include memory that stores a plurality of configured communication quality parameters. As used in the present disclosure, the term “mobile device” refers to a mobile phone, a smartphone, a smartwatch, a tablet computer, a laptop, a personal digital assistant (PDA), a mobile and remote-controlled video-conferencing machine (i.e., a mobile telemedicine robot), or any other mobile device with a network interface for transmitting data over a communications network (e.g. a wireless communication badge). In such embodiment, because the mobile device may be carried by the healthcare provider or stored on his or her person, it can monitor provider-patient conversations and collect valuable data about the healthcare provider's verbal communications in an automatic, passive, and unobtrusive fashion. The mobile device may include a microphone that receives audio data produced by the healthcare provider during interaction with a patient. The mobile device may further include a processor that executes instructions stored in memory. Execution of the instructions by the processor may cause the mobile device to extract communication quality data from the audio data based on the communication quality parameters. Execution of the instructions may further cause the mobile device to generate feedback information regarding one or more communication skills of the healthcare provider based on the extracted communication quality data. The mobile device may also contain a graphical user interface that displays the generated feedback information in real-time. The mobile device may further include a secure communication interface for wirelessly transmitting the audio data over a communication network for remote processing by the system.

An exemplary method of automatically evaluating and providing feedback on verbal communications of a healthcare provider may include storing in memory of a mobile device a plurality of configured communication quality parameters. The method may further include receiving through a microphone of the mobile device audio data produced by the healthcare provider during interaction with a patient. The method may also include executing instructions stored in memory of the mobile device. Execution of the instructions by a processor of the mobile device may cause the mobile device to extract communication quality data from the audio data based on the communication quality parameters. Execution of the instructions may further cause the mobile device to generate feedback information regarding one or more communication skills of the healthcare provider based on the extracted communication quality data. The method may further include displaying the feedback information in real-time through a graphical user interface.

In an embodiment, a system for automatically evaluating and providing feedback on verbal communications of a healthcare provider may include a mobile device, a server, and a graphical user interface. The mobile device may receive audio data from a healthcare provider during a provider-patient conversation. The system may receive the audio data through a microphone of the mobile device. The system may monitor and analyze the conversation based on a plurality of communication quality parameters that it receives from the healthcare provider, hospital administrator, or some other related party. For instance, one such parameter may be a binary “YES” or “NO” indication of whether the healthcare provider verbally informed the patient that one treatment option for the patient's condition is to forgo treatment altogether. As discussed below, other parameters may relate to a healthcare provider's language, empathy, speech tempo, ability to listen and reflect back his or her understanding, and the like.

The server may include memory that stores the plurality of communication quality parameters after they are received over the communications network from the mobile device via a communication interface. Alternatively, the communication quality parameters may be stored locally in memory of the mobile device. The server may also include a processor that executes instructions stored in memory. Execution of the instructions by the processor may cause the server to extract communication quality data from the audio data based on the communication quality parameters. Execution of the instructions by the processor may further cause the server to generate feedback information regarding one or more communication skills of the healthcare provider based on the extracted communication quality data. The graphical user interface may display the generated feedback information in real-time.

In some embodiments, the system may display the feedback information in real-time. In other embodiments, the system may processor and display the feedback in near real-time. As a result, healthcare providers may be able to react to the feedback information and adjust their verbal communications rapidly on a patient-by-patient basis. The system may generate the feedback information by applying a healthcare metric algorithm directly to the extracted communication quality data or, in some embodiments, to the raw audio data. In an embodiment, the algorithm may determine a value assigned to one or more variables, such as an empathy variable. The system may also post-process the feedback information into report data, which may then be displayed graphically on the graphical user interface or archived in a database for future reporting purposes. The reporting data may be processed and displayed on a provider-by-provider basis, or it may be aggregated at multiple levels (e.g., it may include business intelligence trending that, among other possible metrics, tracks the communication quality of an entire team of providers, department, facility, or system over an extended period of time).

FIG. 1 is a block diagram of an exemplary network environment in which a system for automatically evaluating and providing feedback on verbal communications of a healthcare provider may be implemented. The system may be implemented as a network service. The service may provide a series of graphical displays via a graphical user interface. System 100 may include mobile device 110, a communication network 120, and a server 130. Mobile device 110 may communicate with server 130 over network 120. Server 130 may communicate with computing device 140 over network 120. Network 120 may be implemented as a private network, public network, WAN, LAN, an intranet, the Internet, or a combination of these or other networks.

Mobile device 110 may be a smartphone, tablet computer, laptop, PDA, or other mobile device for accessing information over network 120. Mobile device 110 may include one or more executable applications stored in memory that, when executed, permit a user to view content provided by server 130 over network 120 or generated locally within mobile device 110. Server 130 may include one or more computing devices that provide a network service over network 120. Computing device 140 may be a mobile device like mobile device 110, or it may be a stationary computing device such as a desktop computer. The network service may allow the system to generate, store, and provide healthcare service quality information, feedback information, or reporting data. For example, as discussed below in further detail, mobile device 110 may be used to configure system parameters, capture audio data, and transmit the audio data to server 130 over network 120. Server 130 may store and process audio data, generate reporting and business intelligence trending data, and transmit the data to both mobile device 110 (e.g., back to the healthcare provider using the system) and to computing device 140 (e.g., back to the hospital administrator managing the system). In various embodiments, various functionalities described herein that occur after the mobile device captures the audio data may be distributed to various degrees across either mobile device 110, server 130, or one or more intermediate computing devices as appropriate based on the available computing and networking resources.

FIG. 2 is a workflow diagram of an exemplary system that automatically evaluates and provides feedback on verbal communications of a healthcare provider. A system 200 that automatically evaluates and provides feedback on verbal communications of a healthcare provider may include a mobile device. The mobile device may include a graphical user interface, a microphone, executable instructions stored in memory (e.g., within a non-transitory computer-readable storage medium), and a processor. The microphone may be internal, or it could be external, such as a Bluetooth microphone. As explained below in further detail, the mobile device may be a smartphone, tablet computer, laptop, or any other mobile device known in the art. At block 210, the system receives a plurality of user-configurable communication quality parameters that determine how communication quality data is to be extracted from audio data captured by the mobile device. The communication quality parameters may be pre-defined, or they may be configured and inputted into the system directly by the healthcare provider (i.e., the user). The communication quality parameters may be categorized based on area of focus (e.g., introductions, explanations, reassurance). The system may receive the parameters by a graphical user interface, which may be present in the mobile device or a separate computing device.

At block 205, the healthcare provider may power on the mobile device and configure various pre-defined or selected controls, such as preferences related to color, text size, whether the application should launch on start-up, and other similar features. At block 215, the system may receive audio data from the healthcare provider through the microphone of the mobile device. At blocks 220 and 225, a speech recognition engine and/or speech analytics engine may extract communication quality data from the audio data based on the communication quality parameters configured at block 210. The speech recognition engine may identify certain portions of incoming audio data as speech to be analyzed by the speech analytics engine. In an embodiment, the communication quality parameters may include a tally of keywords of interest matched against a keyword library stored in database on a remote server. In other embodiments, the parameters may focus on phonetics, context, spoken tone, and speech volume. At block 225, the system may generate real-time or near real-time feedback information based on the extracted communication quality data.

The system may recognize speech, such as certain words, phrases, or sentences, or various combinations thereof, using any suitable speech recognition engine, many variations of which are known in the art. For example, as shown at block 225, in some embodiments the speech analytics engine may analyze the audio data based on the various communication quality parameters configured by the healthcare provider or pre-defined by an administrator (e.g., a hospital administrator), such as parameters directed at frequency of keywords, or phonetics, spoken tone, and speech volume. The choice of the most optimal speech recognition engine in any given embodiment will depend on various design constraints, such as the processing power and memory capacity of the mobile device. Depending on the communication quality parameters input at block 210, the system may recognize, extract, and analyze indicators of high quality verbal communications, or indicators of low quality verbal communications (e.g., undesired long periods of silence or the use of rude or inappropriate language).

In some embodiments, either the speech recognition and/or analytics engine may reside on-board on the mobile device, while in other embodiments one or more of the engines may reside on an external computing device, such as a server. In the latter case, the mobile device may communicate with the remote engine through a network and may incorporate cloud-computing and/or cloud-storage technologies. Namely, the system may run the engines and/or any mobile applications through which the healthcare provider and/or system administrator may interact with the system via a graphical user interface as network-based services. For example, the mobile device may contain an application stored in memory that, when executed by a processor of the mobile device, captures the audio data and runs the speech recognition engine. The speech recognition engine may identify particular segments of the audio data as relevant to the communication quality data and may forward the selected audio data to a remote application server running the speech analytics engine. The speech analytics engine may process the quality data, generate feedback, and then transmit the feedback back to the mobile device to be displayed to the healthcare provider through a graphical user interface. All of the foregoing may occur in real-time or near real-time. Communication quality data may include the topic that was discussed in the healthcare provider-patient conversation, the emotional character of the speech, or the amount and locations of speech versus non-speech, including periods of silence. The communication quality data will vary depending on the communication quality parameters configured at any given time. In some embodiments, the system may not record audio data so as to remain compliant with the Health Insurance Portability and Accountability Act (HIPAA) privacy laws.

The system, either at the mobile device or a separate computing device, may contain instructions stored in memory that, when executed, automatically evaluates the audio data captured by the mobile device and distinguishes between the known (i.e. previously captured, analyzed, and stored) voice of a healthcare provider and unknown persons that might produce audio data near the mobile device (e.g., statements made by the patient).

At block 230, the system may display the feedback information on the graphical user interface of the mobile device. The feedback information may be displayed on the graphical user interface in real-time or near real-time. For example, the graphical user interface may display feedback information about a healthcare provider immediately after the healthcare provider leaves a patient room. As a result, the healthcare provider may immediately learn whether or not to adjust his or her verbal communications based on the previous conversation with the patient. The system may incorporate gamification techniques to create interesting, stimulating, and engaging experiences for the healthcare providers (e.g., earning points or badges for receiving positive feedback). When using such embodiments, healthcare providers may be incentivized to strive for better communications with patients in real-time or near real-time without having to wait for a periodic or otherwise delayed form of review from a supervisor.

The system may also generate the feedback information based on the extracted healthcare communication quality data by applying a healthcare metric algorithm. Generating the feedback information may include a step of calculating particular scores designated by the healthcare provider or a system administrator during the setup process. Such scores may include an empathy score or any number of other possible qualitative and quantitative assessment variables. Such variables may themselves be comprised of functions containing sub-variables. For instance, in an embodiment, an empathy variable may be determined by a function containing a spoken tone sub-variable, a reflection sub-variable, and/or a keyword tally sub-variable. The sub-variables may be values assigned by the system based on the audio data received from the healthcare provider. Where the spoken tone of the healthcare provider is flat, for example, the system may assign a lower value to the spoken tone sub-variable than had the audio data indicated that the healthcare provider spoke to the patient in a modulated and/or expressive spoken tone. Similarly, where a high percentage of the terms within audio data received by the system from the healthcare provider match the terms within audio data received by the system from the patient, the system may assign a high value to the reflection sub-variable to account for the healthcare provider's demonstration of his or her reflective listening.

The keyword tally sub-variable may be a value assigned by the system based on the number of terms or collections of terms (e.g., phrases) within the audio data received by the system from the healthcare provider that match certain pre-defined keywords stored in memory of the mobile computing device or a separate database communicatively coupled to the mobile device. As used in this disclosure, the term “keyword” may refer to a single term or a collection of terms (e.g., a phrase). The system may assign a value to the keyword tally sub-variable that varies according to the number of detected terms that match a keyword in the database. The healthcare provider himself or herself may configure the keywords stored in the mobile device or database by using a variety of input controls displayed on the graphical user interface of the mobile device. As a result, the healthcare provider can adjust the system in response to real-time or near real-time feedback provided by the system in an effort to constantly refine his or her bedside manner and communication skills. In some embodiments, as part of the feedback described above, the system may continuously monitor a score and may provide an alert to the healthcare provider when the score ascends to or drops below a certain level. The alert may origin from either the mobile device or a remote computing device communicably coupled to the mobile device and may be displayed on a graphical user interface. Alternatively, the alert may be sent to a separate computing device such as a desktop computer as might be necessary to alert an administrator of an ongoing problem with a particular healthcare provider's communication skills. Relatedly, the system may automatically transmit reminders to the healthcare provider by way of the mobile device when certain keywords are not detected for a threshold period of time or at a threshold frequency. The content and format of the feedback information will vary depending on design considerations and individual health provider needs, such as whether or not a healthcare provider needs to work on verbally communicating more empathy or remembering to communicate certain information related to meeting informed consent or standard of care requirements.

The system may include one or more healthcare-related dictionaries or libraries stored in a database of a server. One such library may contain a list of healthcare-related keywords categorized by type of healthcare service or characteristics associated with a patient, such as age, gender, or geography. During setup, the system may receive keyword parameters that direct the system to access a particular list of keywords. For instance, during setup, a healthcare provider may use a mobile device of the system to input “Depression” as a keyword parameter. The system may receive the parameter and access a list of keywords that, if verbalized by the healthcare provider, would serve as indicators of high quality communications to a patient suffering from depression. Similarly, the system may automatically select various parameters from one or more databases based on a specific role of the healthcare provider.

The system may store the extracted healthcare communication quality data in memory of the mobile device, or it may store the data in a database of a separate computing device communicatively coupled to the mobile device by a network as shown at block 235. At block 240, the system may post-process the extracted healthcare communication quality data and generate report data. As shown at block 245, the system may then post-process the report data into one or more graphical reports. The graphical reports may be displayed directly to the healthcare provider on the graphical user interface of the mobile device. The graphical reports may facilitate data analysis at the health provider, hospital, and patient level. They may also be provided to point to high performers, outliers, or to highlight opportunities for quality improvement.

FIG. 3 is a block diagram of an exemplary mobile device. The mobile device 300 of FIG. 3 may include one or more processors 310 and memory 312. Memory 312 stores, in part, programs, applications, instructions, and/or data for execution and processing by processor 310. The system 300 of FIG. 3 may further include storage 314, one or more antennas 316, a display system 318, inputs 320, one or more microphones 322, and one or more speakers 324.

The components shown in FIG. 3 are depicted as being connected via a single bus 326. However, components 310-324 may be communicatively coupled through one or more data transport means. For example, processor unit 310 and main memory 312 may be communicatively coupled via a local microprocessor bus, while storage 314, display system 318, input 320, and microphone 322 and speaker 324 may be connected via one or more input/output (I/O) buses.

Memory 312 may include local memory such as random access memory (RAM) and read-only memory (ROM), portable memory in the form of an insertable memory card or other attachment (e.g., via universal serial bus), a magnetic disk drive or an optical disk drive, a form of Flash or programmable read-only memory (PROM), or other electronic storage medium. Memory 312 can store the system software for implementing some embodiments for purposes of loading that software into main memory 310.

Antenna 316 may include one or more antennas for communicating wirelessly with another device. Antenna 316 may be used, for example, to communicate wirelessly via “Wi-Fi,” “Bluetooth,” with a cellular network, or with other wireless protocols and systems. The one or more antennas may be controlled by a processor 310, which may include a controller, to transmit and receive wireless signals. For example, processor 310 may execute programs or applications stored in memory 312 to control antenna 316 to transmit and receive a wireless signal to and from a cellular network.

Display system 318 may include any display system typically found in mobile devices (e.g., smartphones), such as a liquid crystal display (LCD), a touch screen display, or other suitable display device. Display system 318 may be controlled to display textual and graphical information and output to text and graphics through a display device. When implemented with a touch screen display, the display system may receive input and transmit the input to processor 310 and memory 312.

Input devices 320 provide a portion of a graphical user interface. Input devices 320 may include an alpha-numeric keypad, such as a keyboard, or a touchscreen keypad for inputting alpha-numeric and other information, buttons or switches, a trackball, stylus, or cursor direction keys. Microphone 322 may include one or more microphone devices which transmit captured acoustic signals to processor 310 and memory 312. The acoustic signals may be processed to transmit over a network via antenna 316.

Speaker 324 may provide an audio output for mobile device 300. For example, a signal received at antenna 316 may be processed by a program stored in memory 312 and executed by processor 310. The output of the executed program may be provided to speaker 324, which then provides audio. Additionally, processor 310 may generate an audio signal, for example an audible alert, and output the audible alert through speaker 324.

The mobile device system 300 as shown in FIG. 3 may include devices and components in addition to those illustrated in FIG. 3. For example, mobile device system 300 may include an additional network interface such as a universal serial bus (USB) port. The components contained in the computer system 300 of FIG. 3 are those typically found in mobile device systems that may be suitable for use with some embodiments and are intended to represent a broad category of such mobile device components that are well-known in the art. Thus, the computer system 300 of FIG. 3 may be a cellular phone, smart phone, hand-held computing device, laptop, minicomputer, netbook, or any other mobile computing device. The mobile device can also include different bus configurations, networked platforms, multi-processor platforms, etc. Various operating systems can be used including Unix, Linux, Windows, Macintosh Operating System (OS), Google OS, Palm OS, and other suitable operating systems.

A method of automatically evaluating and providing feedback on verbal communications of a healthcare provider may include receiving several configured communication quality parameters from a healthcare provider through a graphical user interface of a mobile device. The method may also include receiving, through a microphone of the mobile device, audio data produced by the healthcare provider during a conversation with a patient. The method may further include executing instructions stored in memory of the mobile device. Execution of the instructions by a processor of the mobile device may cause the processor to extract communication quality data from the audio data based on the communication quality parameters. The processor may further generate feedback information regarding one or more communication skills of the healthcare provider based on the extracted communication quality data. The processor may also display the feedback information to the healthcare provider in real-time or near real-time through the graphical user interface.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A mobile device for automatically evaluating and providing feedback on verbal communications of a healthcare provider; the mobile device comprising:
memory that stores a plurality of configured communication quality parameters;
a microphone that receives audio data produced by the healthcare provider during interaction with a patient;
a processor that executes instructions stored in memory, wherein execution of the instructions by the processor:
extracts communication quality data from the audio data based on the communication quality parameters, and
generates feedback information regarding one or more communication skills of the healthcare provider based on the extracted communication quality data, and
a graphical user interface that displays the generated feedback information in real-time.

2. The mobile device of claim 1, wherein the plurality of configured communication quality parameters are configured by the healthcare provider by way of the graphical user interface.

3. The mobile device of claim 1, wherein the processor generates the feedback information by applying a healthcare metric algorithm to the extracted communication quality data.

4. The mobile device of claim 3, wherein the feedback information includes a value assigned to an empathy variable.

5. The mobile device of claim 3, wherein the healthcare metric algorithm includes two or more sub-variables selected from:
a spoken tone sub-variable;
a reflection sub-variable; and
a keyword sub-variable.

6. The mobile device of claim 5, wherein the processor executes instructions to assign a value to the spoken tone sub-variable based on whether the audio data indicates that a tone of the healthcare provider was expressive or flat.

7. The mobile device of claim 5, wherein the microphone further receives audio data from the patient and wherein the processor executes instructions to assign a value to the reflection sub-variable based on a percentage of terms within the audio data from the healthcare provider that match terms within audio data from the patient.

8. The mobile device of claim 5, wherein the processor executes instructions to assign a value to the keyword sub-variable based on a number of terms within the audio data from the healthcare provider that match one or more pre-defined keywords.

9. The mobile device of claim 1, wherein the feedback information includes an empathy score.

10. The mobile device of claim 1, wherein the memory further includes a database for storing the extracted healthcare communication quality data.

11. The mobile device of claim 1, wherein the processor generates a display of the feedback information by post-processing the extracted healthcare communication quality data into report data.

12. The mobile device of claim 11, wherein the report data comprises one or more graphical reports, and wherein the generated display of the feedback information displayed by the graphic user interface includes the one or more graphical reports.

13. A method of automatically evaluating and providing feedback on verbal communications of a healthcare provider, the method comprising:
storing in memory of a mobile device a plurality of configured communication quality parameters;
receiving through a microphone of the mobile device audio data produced by the healthcare provider during interaction with a patient; and
executing instructions stored in memory of the mobile device, wherein execution of the instructions by a processor of the mobile device:
extracts communication quality data from the audio data based on the communication quality parameters, and
generates feedback information regarding one or more communication skills of the healthcare provider based on the extracted communication quality data, and
displaying the feedback information in real-time through a graphical user interface.

14. The method of claim 13, wherein generating the feedback information comprises applying a healthcare metric algorithm to the extracted communication quality data.

15. The method of claim 14, wherein generating the feedback information comprises assigning a value to an empathy variable.

16. The method of claim 14, wherein the healthcare metric algorithm includes two or more sub-variables selected from:
a spoken tone sub-variable;
a reflection sub-variable; and
a keyword sub-variable.

17. The method of claim 16, further comprising executing instructions to assign a value to the spoken tone sub-variable based on whether the audio data indicates that a tone of the healthcare provider was expressive or flat.

18. The method of claim 16, further comprising receiving audio data from the patient, and executing instructions to assign a value to the reflection sub-variable based on a percentage of terms within the audio data from the healthcare provider that match terms within the audio data from the patient.

19. The method of claim 16, further comprising executing instructions to assign a value to the keyword sub-variable based on a number of terms within the audio data from the healthcare provider that match one or more pre-defined keywords.

20. A system for automatically evaluating and providing feedback on verbal communications of a healthcare provider; the system comprising:
a mobile device comprising:
a microphone that receives audio data produced by the healthcare provider during interaction with a patient, and
a communication interface for wirelessly transmitting the audio data over a communication network;
a server comprising:
memory that stores a plurality of configured communication quality parameters,
a communication interface for receiving the audio data sent wirelessly over the communication network from the mobile device;
a processor that executes instructions stored in memory, wherein execution of the instructions by the processor:
extracts communication quality data from the audio data based on the communication quality parameters, and
generates feedback information regarding one or more communication skills of the healthcare provider based on the extracted communication quality data, and
a graphical user interface that displays the generated feedback information in real-time.
